(19) United States
(12) Patent Application Publication
(10) Pub. No.: US 2006/0190204 A1
(43) Pub. Date: Aug. 24, 2006

(54) Analyzing the response of an electrochemical system to a time-varying electrical stimulation

(76) Inventors: John McHardy, Oxnard, CA (US); Kurt Salloux, San Francisco, CA (US); Paul W. Swanton, Topanga, CA (US)

Correspondence Address: Mark S. Leonardo, Esq.;Brown Rudnick Berlack Israels LLP, One Financial Center, Boston, MA, 02111, US

(21) Appl. No.: 11/337,914

(22) Filed: Jan. 23, 2006

Related U.S. Application Data
(63) Continuation-in-part of application No. 10/666,567, filed on Sep. 19, 2003, now Pat. No. 6,990,422.
Application No. 10/666,567 is a continuation-in-part of application No. 10/443,230, filed on May 21, 2003.
Application No. 10/666,567 is a continuation-in-part of application No. 09/122,181, filed on Jul. 24, 1998, now abandoned.
Application No. 10/443,230 is a continuation-in-part of application No. 09/122,181, filed on Jul. 24, 1998, now abandoned.
Application No. 10/443,230 is a continuation-in-part of application No. PCT/US97/05002, filed on Mar. 27, 1997.
(60) Provisional application No. 60/054,466, filed on Jul. 25, 1997.
(60) Provisional application No. 60/054,466, filed on Jul. 25, 1997.
(60) Provisional application No. 60/014,159, filed on Mar. 27, 1996.

(51) Int. Cl. G01D 3/00

(52) U.S. Cl. 702/109

(57) ABSTRACT

The invention provides a method for capturing and analyzing the total electrical response to a time-varying electrical stimulation of a system or device containing electrochemically active biological or non-biological substances. The response can be either a time-varying voltage (in the case of current-mode stimulation), or a time-varying current (in the case of voltage-mode stimulation). Using synchronous data acquisition technology and advanced data analysis, the method yields not only the idealized 2-parameter information (e.g., phase and amplitude) provided by conventional methods, but also parameters extracted from non-ideal features of the response waveform that are suppressed by impedance methods. By extracting the full range of response characteristics, the method yields a multi-parameter representation of the system or device under test. The inventive methods may be embodied in an open-loop form, wherein the results of measurements and analysis are reported to the operator, or in a closed-loop form, wherein said results are fed back to modulate the behavior of the system or device.

### RELATED APPLICATION INFORMATION

This patent application is a continuation-in-part of U.S. Utility patent application Ser. No. 10/666,567, filed in the U.S. Patent and Trademark Office on Sep. 19, 2003, which is a continuation-in-part of U.S. Utility patent application Ser. No. 10/443,230, filed in the U.S. Patent and Trademark Office on May 21, 2003 and U.S. Utility patent application Ser. No. 09/122,181 filed in the U.S. Patent and Trademark Office on Jul. 24, 1998, which claims priority to U.S. Provisional Application No. 60/054,466, filed in the U.S. Patent and Trademark Office on Jul. 25, 1997;

whereas U.S. Utility patent application Ser. No. 10/443,230 filed in the U.S. Patent and Trademark Office on May 21, 2003 is a continuation-in-part of U.S. Utility patent application Ser. No. 09/122,181 filed in the U.S. Patent and Trademark Office on Jul. 24, 1998, which claims priority to U.S. Provisional Application No. 60/054,466, filed in the U.S. Patent and Trademark Office on Jul. 25, 1997; and

whereas U.S. Utility patent application Ser. No. 09/122,181, filed in the U.S. Patent and Trademark Office on Jul. 24, 1998, which claims priority to U.S. Provisional Application No. 60/054,466, filed in the U.S. Patent and Trademark Office on Jul. 25, 1997 is a continuation-in-part of PCT/US97/05002, filed in the U.S. Patent and Trademark Office on Mar. 27, 1997, which claims priority to U.S. Provisional Application No. 60/014,159, filed in the U.S. Patent and Trademark Office on Mar. 27, 1996, and whereby the entire contents of each are incorporated herein by reference in their entireties.

### FIELD OF THE INVENTION

The invention relates generally to the testing of electrochemical systems or devices containing biological or non-biological substances that respond to time-varying electrical stimulation. More particularly, it provides a method for extracting detailed information about the system from its time-varying electrical response.

### BACKGROUND OF THE INVENTION

Impedance methods for probing electrochemical systems and devices utilize only a small part of the total information contained in the response waveform. Under those methods, a system or device is stimulated with a sinusoidal current or voltage with a time-averaged value of zero. The response is analyzed in terms of the impedance, Z, a two-dimensional vector usually represented as a point in the complex plane. The analysis assumes that the response waveform differs from the stimulation waveform only in amplitude and phase. However, unlike networks of passive electronic components such as resistors and capacitors, electrochemical systems yield response waveforms that contain significant distortions. By treating the response waveform as a pure sine wave, impedance analysis not only suppresses information embedded in the distortions, it also complicates the interpretation. For example, the common practice of fitting an electrochemical system to an “equivalent circuit” of passive components often requires artificial constructs such as the “constant phase element” and the “virtual inductor.” See for example, the “Electrochemical Impedance Spectroscopy Primer,” Gamry Instruments, at http://www.gamry.com 2005, which is incorporated herein in its entirety. To avoid the limitations of impedance analysis we created a more direct method for characterizing electrochemical systems and devices.

### SUMMARY OF THE INVENTION

The invention provides a method for capturing and analyzing the total electrical response to a time-varying electrical stimulation of a system or device containing electrochemically active biological or non-biological substances. The response can be either a time-varying voltage (in the case of current-mode stimulation), or a time-varying current (in the case of voltage-mode stimulation). Using synchronous data acquisition technology and advanced data analysis, the method yields not only the idealized 2-parameter information (e.g., phase and amplitude) provided by conventional methods, but also parameters extracted from non-ideal features of the response waveform that are suppressed by impedance methods. By extracting the full range of response characteristics, the method yields a multi-parameter representation of the system or device under test. The inventive methods may be embodied in an open-loop form, wherein the results of measurements and analysis are reported to the operator, or in a closed-loop form, wherein said results are fed back to modulate the behavior of the system or device.

A method for obtaining detailed information about an electrochemical system such as a cell or array of cells by providing at least two electronic conductors or electrodes in contact with a common ionic conductor or electrolyte and analyzing the electrical response of the system to a time-varying electrical stimulation. The system may be analytical cell having a common ionic conductor that includes a dissolved biological species. The information of the system may include properties of interest such as identity, concentration, oxidation state, and other characteristics of the biological species.

Additionally, where the dissolved biological species includes a known concentration and oxidation state, the properties of interest include the calibration constants of the cell.

Also, where the system includes a rechargeable battery with electronic conductors that include porous active materials supported on current collectors, the properties of interest include the physical and chemical characteristics of functional components such as electrodes, electrolyte, and current collectors.

Furthermore, where the system is an electrochemical fuel cell, with electronic conductors that include porous active materials supported on current collectors, the properties of interest include the degree of the common ionic conductor permeation into the pores of electronic conductors and the activity of catalyst particles within those pores.

Moreover, where the system is an analytical cell and one of the electronic conductors is a metal surface that has been coated or otherwise treated to resist corrosion, the properties of interest include the integrity of the coating and the extent to which corrosion has taken place beneath it.

### BRIEF DESCRIPTION OF THE DRAWINGS

The foregoing and other features and advantages of the present invention will be more fully understood from the following detailed description of illustrative embodiments, taken in conjunction with the accompanying drawing in which:

FIG. 1 is a view of conjugate stimulation and response waveforms for an ideal capacitor;

FIG. 2a is a view of an asymmetric current-time response of a 6-volt lead-acid battery to triangular voltage stimulation;

FIG. 2b is a view of an asymmetric charge-time response of a 6-volt lead-acid battery to triangular voltage stimulation;

FIG. 2c is a view of a charge-time response after compensation for asymmetry of a 6-volt lead-acid battery to triangular voltage stimulation; and

FIG. 3 is a view of a relationship between charge asymmetry and signal frequency for a 6-volt lead-acid battery subject to triangular voltage stimulation

### DETAILED DESCRIPTION OF THE INVENTION

The invention provides a method for analyzing the total electrical response to a time-varying electrical stimulation of a system or device containing electrochemically active biological or non-biological substances.

The various preferred stimulation signals may be usefully distinguished according to several key characteristics. By convention, a single stimulation “cycle” may be described as a time varying signal that exists for a fixed (and finite) duration, and exhibits at least two or more distinct amplitudes during the cycle; the signal may be characterized either as a voltage or a current. Whenever a signal exhibits more than one amplitude value, it is know as an “AC” signal. Stimulation signals may be generated by conventional analog circuitry means, such as fixed or adjustable oscillators, or by digital means that embody digital-to-analog converters whose output voltage amplitude may be changed in discrete steps under external control such as may be provided by a microcontroller or other logic device. In the preferred embodiment, a reference clock may be provided as well, to serve as a phase reference (with respect to the stimulation), so that various types of data acquisition and analysis techniques may be properly applied.

A single cycle of an AC signal may either be unipolar or bipolar. Within a unipolar signal, all of the amplitude values have the same relative polarity, with respect to a common reference point, called the “ground” reference point, or simply “ground,” with the understanding that the set of amplitudes of unipolar signals of either polarity includes zero with respect to ground (that is, may appear at the common potential). Thus, a signal that alternates, say, between some positive (or negative) value and common value (where amplitude is exactly “zero”) is also to be considered a unipolar signal.

In contrast, the polarity of a bipolar signal will undergo one and only one change of polarity within each whole cycle; in this case, a single signal cycle must exhibit one portion that is positive (that is, above ground) and another distinct portion that is negative (that is, below ground).

Common examples of a single cycle stimulation signals include a sine wave, a square wave, a triangle wave, and a unipolar step (wherein the signal amplitude executes an abrupt transition between two otherwise constant amplitude values). When a plurality of identical cycles is seamlessly joined together in time, the result is referred to as a periodic signal; if several periodic (but dissimilar) signal segments are added together, the resulting sum is a quasi-periodic signal. Other useful types of stimulation may include a rectilinear waveform, exhibiting a leading edge that constitutes an abrupt amplitude transition, followed by a substantially constant-amplitude portion, followed by another abrupt amplitude transition representing a trailing edge; or a ramping waveform comprising, in either order, an abrupt amplitude step representing an abrupt amplitude and a portion whose amplitude varies with time in a linear fashion (an so may be characterized as a ramp), thus exhibiting a constant, but non-zero, first derivative with respect to time.

Quantitative features of the response waveform (viz., a time-varying voltage in the case of current-mode stimulation and a time-varying current or charge in the case of voltage-mode stimulation) are analyzed to characterize various properties of the system or device. The analysis can be based on various parameters such as:

1) The first and second time derivatives;

2) The harmonic components (i.e. the power spectrum) and optionally the phase of each component with respect to the phase of the stimulation signal;

3) Waveform distortions (i.e., deviations from the ideal response)

Distortion can be classified into three distinct categories:

The first is frequency distortion that arises when the system or device under test contains elements with resonant characteristics that produce peaks or dips in an otherwise flat frequency response curve.

The second is a type of distortion that arises when the system or device under test contains elements with non-linear electrical characteristics that alter the shape of the response waveform at a given frequency.

The third is delay or phase distortion, which is distortion produced by a shift in phase between one or more components of a complex waveform.

Applying a time-varying stimulation to an electrochemical device will typically elicit a response that depends on many factors. These factors may include the amplitude, frequency, and polarity of the stimulation signal, the cumulative effect of prior perturbations, and ambient conditions such as temperature.

Time varying stimulation signals may either exhibit a time-averaged value of zero (over any integer number of whole cycles), or may have a net bias, wherein the average value is not zero for some or all of the duration of the stimulation (which itself is understood to comprise one or more whole cycles). When a net bias is present, the device under test will thereby be subjected to an overall charging or discharging event, for a positive or negative net bias, respectively. Note that any time-varying signal that exhibits a net bias may be decomposed into two or more independent components, one of which may be (but not necessarily) a DC component.

An important type of distortion occurs when the response waveform exhibits asymmetry about the time axis. The asymmetry can arise from phenomena such as partial rectification of the stimulation signal by surface films or differing electrochemical reactions in the forward and backward directions.

### EXAMPLE

The following non-limiting example is presented only to clarify basic aspects of the method described herein and in no way does it limit the scope of the present invention.

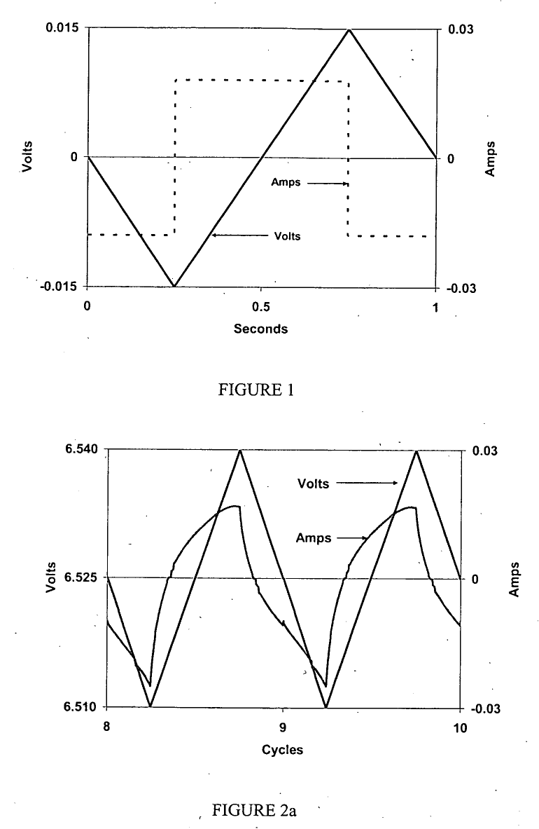

With reference to FIG. 1 there is depicted the conjugate relationship between stimulation and response waveforms for a pure capacitor. When the capacitor is stimulated with a 1 Hz triangular voltage wave, the response is a 1 Hz square wave current. Conversely, when the capacitor is stimulated with a square wave current, the response is a triangular voltage wave. By virtue of the amplitude and temporal symmetries, each waveform exhibits a time-average value of zero (i.e., has no DC offset component). An electrochemical device typically exhibits more complex behavior.

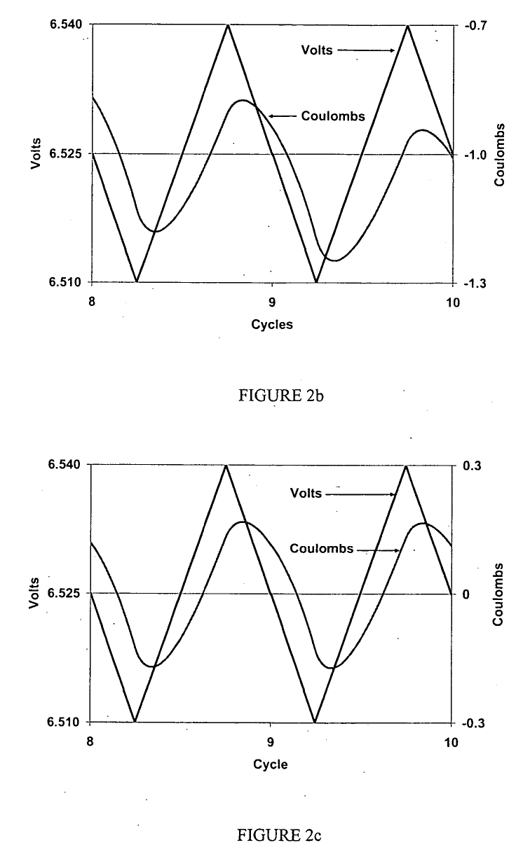

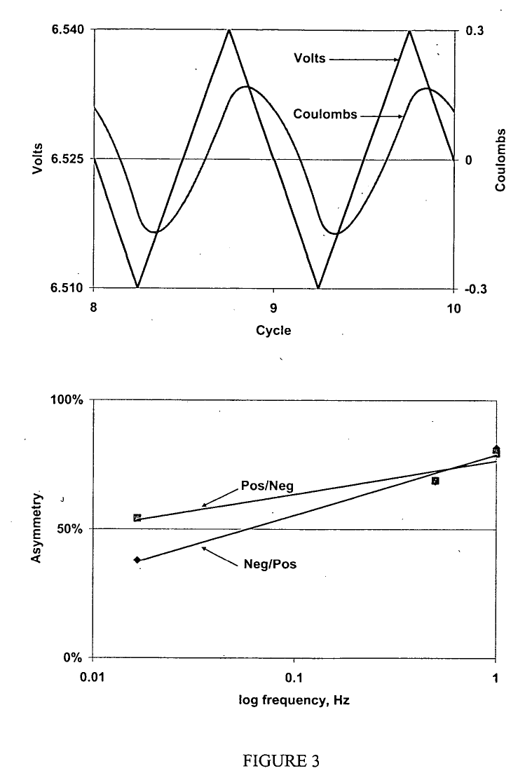

Now referring to FIGS. 2a-2c there are depicted cycles 9 and 10 during the stimulation of a 3-cell lead acid battery with a triangular voltage wave. FIG. 2a shows that the current-time response is highly asymmetric, containing significantly more charge in the negative half-cycle (represented by the area between the curve and the time axis) than in the positive half cycle. FIG. 2b shows that the asymmetry is even more apparent in the corresponding charge-time response. The excess negative charge in each cycle is equivalent to a DC bias current. FIG. 2c shows the charge-time waveform after mathematically compensating it for this bias current. FIG. 3 shows that the degree of asymmetry varies with both the frequency and polarity of the stimulating signal.

1. A method for obtaining detailed information about an electrochemical system such as a cell or array of cells comprising:
providing at least two electronic conductors in contact with a common ionic conductor; and
analyzing the electrical response of the system to a time-varying electrical stimulation.

2. The method for obtaining detailed information about an electrochemical system of claim 1, wherein the system is an analytical cell.

3. The method for obtaining detailed information about an electrochemical system of claim 1, wherein the common ionic conductor contains dissolved biological species.

4. The method for obtaining detailed information about an electrochemical system of claim 1, wherein the step of analyzing further comprises properties of interest include the identity, concentration, oxidation state, and other characteristics of the biological species.

5. The method for obtaining detailed information about an electrochemical system of claim 3, wherein the dissolved biological species includes a known concentration and oxidation state and the properties of interest include the calibration constants of the cell.

6. The method for obtaining detailed information about an electrochemical system of claim 1, wherein the system is a rechargeable battery, the at least two electronic conductors including porous active materials supported on current collectors, and the properties of interest include the physical and chemical characteristics of functional components such as electrodes, electrolyte, and current collectors.

7. The method for obtaining detailed information about an electrochemical system of claim 1, wherein the system is an electrochemical fuel cell, the at least two electronic conductors consist of porous active materials supported on current collectors and the properties of interest include the degree of the common ionic conductor permeation into the pores of each of the at least two electronic conductors and the activity of catalyst particles within those pores.

8. The method for obtaining detailed information about an electrochemical system of claim 1, wherein the system is an analytical cell, one of the at least two electronic conductors is a metal surface that has been coated or otherwise treated to resist corrosion and the properties of interest include the integrity of the coating and the extent to which corrosion has taken place beneath it.
